(19) United States
(12) Patent Application Publication
(10) Pub. No.: US 2025/0324298 A1
(43) Pub. Date: Oct. 16, 2025

(54) PERFORMANCE OF LAYER-1 (L1) MEASUREMENT OPERATIONS BY A USER EQUIPMENT (UE) ON L1 REFERENCE SIGNALS RECEIVED BY THE UE OUTSIDE OF AN ACTIVE BANDWIDTH PART

(71) Applicant: Apple Inc., Cupertino, CA (US)

(72) Inventors: Qiming Li, Beijing (CN); Dawei Zhang, Saratoga, CA (US); Yang Tang, San Jose, CA (US); Jie Cui, San Jose, CA (US); Xiang Chen, Campbell, CA (US); Huaning Niu, San Jose, CA (US); Manasa Raghavan, Sunnyvale, CA (US); Yushu Zhang, Beijing (CN)

(21) Appl. No.: 18/881,662

(22) PCT Filed: Jul. 7, 2022
(86) PCT No.: PCT/CN2022/104366

§ 371 Date: Jan. 6, 2025

(51) Int. Cl. H04W 24/08; H04L 5/00

(52) U.S. Cl. CPC H04W 24/08; H04L 5/0048

(57) ABSTRACT

A user equipment (UE) includes a transceiver and a processor. The processor is configured to transmit, via the transceiver. UE capability information indicating a UE type. the UE type indicating a relationship between a carrier bandwidth (CBW) and an actual bandwidth (BW) in which the UE operates. The CBW includes a plurality of bandwidth parts (BWPs). The processor is configured to receive, via the transceiver, within the CBW and outside an active BWP of the UE, one or more layer-1 (L1) reference signals (L1-RSs), and perform one or more L1 measurement operations on the received one or more L1-RSs. The one or more L1 measurement operations are performed in accord with the UE type.

### TECHNICAL FIELD

This application relates generally to wireless communication systems, including methods and systems for performing layer-1 measurement operation by a user equipment (UE) based on L1 reference symbols, which are received by the UE outside of an active bandwidth part.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 602.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANS can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2A illustrates a relationship between a carrier bandwidth, bandwidth parts, and an actual bandwidth for one type of a user equipment (UE) in which layer-1 reference signals are received in a single inactive bandwidth part, according to embodiments described herein.

FIG. 2B illustrates a relationship between a carrier bandwidth, bandwidth parts, and an actual bandwidth for another type of a user equipment (UE) in which layer-1 reference signals are received in a single inactive bandwidth part, according to embodiments described herein.

FIG. 3A illustrates a relationship between a carrier bandwidth, bandwidth parts, and an actual bandwidth for one type of a user equipment (UE) in which layer-1 reference signals are received in multiple inactive bandwidth parts, according to embodiments described herein.

FIG. 3B illustrates a relationship between a carrier bandwidth, bandwidth parts, and an actual bandwidth for another type of a user equipment (UE) in which layer-1 reference signals are received in multiple inactive bandwidth parts, according to embodiments described herein.

FIG. 4 illustrates an example flow-chart of operations that may be performed by a UE, according to embodiments described herein.

FIG. 5 illustrates an example flow-chart of operations that may be performed by a base station, according to embodiments described herein.

FIG. 6 illustrates an example architecture of a wireless communication system, according to embodiments described herein.

FIG. 7 illustrates a system for performing signaling between a wireless device and a network device, according to embodiments described herein.

### DETAILED DESCRIPTION

In the present disclosure, various embodiments are related to performing layer-1 (L1) measurement operations on layer-1 reference signals (or reference symbols), that are received at a user equipment (UE) outside of an active bandwidth part (BWP). In RAN2 #117e, a liaison specification (LS) has been approved to RAN4 (R2-2204009) in which layer-1 measurement operations, such as beam level mobility (BM), radio link monitoring (RLM), and/or beam failure detection and recovery (BFD), will be based on a synchronization signal block (SSB) associated with an initial downlink (DL) bandwidth part (BWP), and can only be configured for the initial DL BWPs and for DL BWPs containing the SSB associated with the initial DL BWP. For other DL BWPs, L1 measurement operations can only be performed based on channel state information reference signal (CSI-RS).

A UE, however, can indicate, to a base station and/or a core network, in UE capability signaling that the UE supports a BWP operation without bandwidth restriction. In other words, the DL BWP configured for the UE may not contain an SSB associated with the initial DL BWP. The UE can also indicate in the UE capability signaling that the UE does not support CSI-RS based L1 measurement operations, such as, BM, RLM, and/or BFD, and so on. Accordingly, for the UE, which has indicated that it does not support L1 measurement operations using CSI-RS, the base station and/or the core network may still configure a DL BWP which may not contain an SSB associated with the initial DL BWP. In other words, the DL BWP, which may be an active BWP, may not include an SSB, and the UE may not perform L1 measurement operations using CSI-RS.

Various embodiments in the present disclosure describe how a UE may perform L1 measurement operations using reference signals that are not received or included within the active BWP.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

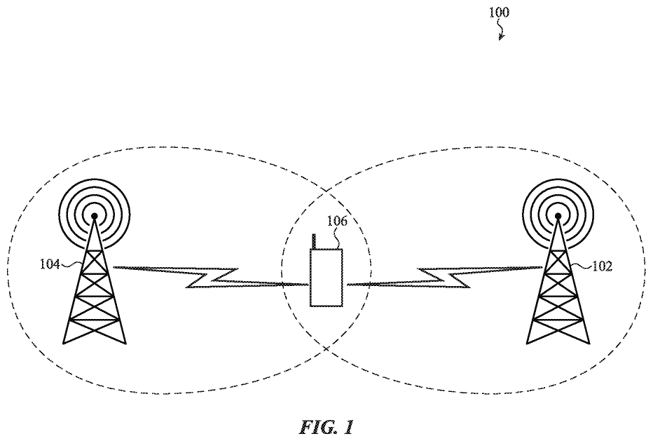

FIG. 1 shows an example wireless communication system, according to embodiments described herein. As shown in FIG. 1, a wireless communication system 100 may include base stations 102 and 104 and a UE 106. The UE 106 may be in a serving cell of a base station, e.g., the base station 102. In some embodiments, the base station 102 and/or 104 may be an eNb, an eNodeB, a gNodeB, or an access point (AP) in a radio access network (RAN) and may support one or more radio access technologies, such as 4G, 5G new radio (5G NR), and so on. The UE 104 may be a phone, a smart phone, a tablet, a smartwatch, an Internet-of-Things (IoT), and so on.

In some embodiments, and by way of a non-limiting example, as shown in the wireless communication system 100, the UE 106 may be connected with the base station 102 and/or the base station 104 in a carrier aggregation (CA) mode of one or more serving carriers. The UE 106 may thus send and/or receive data over one or more component carriers of different frequency bands or frequency ranges, for example, FR1-1, FR1-2, FR2-1, and/or FR2-2. In some cases, the UE 106 may be connected with more than one base station in CA mode and/or non-CA mode. In some embodiments, and by way of a non-limiting example, the UE 106 may also be connected with the base station 102 and/or the base station 104 in non-CA mode.

In 5G NR, carrier bandwidth (or cell bandwidth) (CBW) is larger compared to 4G or long-term evolution (LTE). A UE is, therefore, configured to operate in a subset of the CBW to save UE power. Accordingly, the CBW may be divided into multiple BWPs. However, in some embodiments, and by way of a non-limiting example, only one BWP may be an active BWP at a time. In some embodiments, and by way of a non-limiting example, at a time there may be two or more active BWPs.

For example, the CBW may include an initial BWP, which may be used by the UE to perform an initial access process. The CBW may also include more than one BWP, which may be used by the UE for transmitting data and/or a reference signal to the base station, and/or receiving data and/or a reference signal from the base station, in a connected mode of the UE. An active BWP of the multiple BWPs of a CBW may be configured by the base station using radio resource control (RRC) signaling. Accordingly, an active BWP may be UE specific.

Additionally, or alternatively, a default BWP for a UE may also be configured by the base station using RRC signaling. The default BWP may also be UE specific. In some embodiments, and by way of a non-limiting example, the default BWP may be the initial DL BWP.

The UE may perform one or more measurement operations, for example, for beam management (or beam level mobility), radio link failure monitoring, beam failure detection and recovery, and so on, on one or more SSBs received within the active BWP. The UE may also perform the one or more measurement operations on one or more CSI-RSs received within the active BWP. The UE may be communicated to inform which BWP may include the CSI-RS and/or SSB for the UE to perform one or more measurement operations. Even though the CSI-RS and/or SSB for the UE to perform measurement operations are expected to be transmitted by the base station within the active BWP of the UE, the base station may transmit CSI-RS and/or SSB for the UE to perform L1 measurement operations outside of the active BWP of the UE.

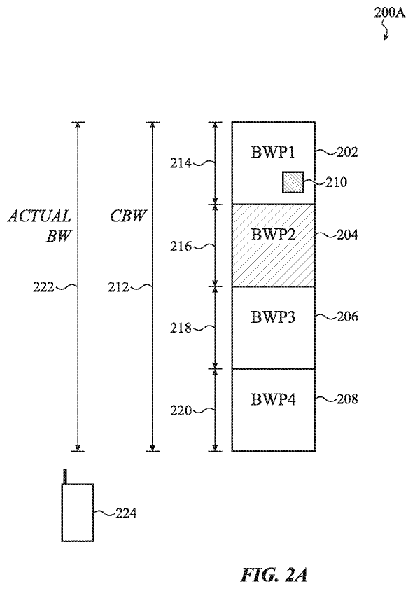

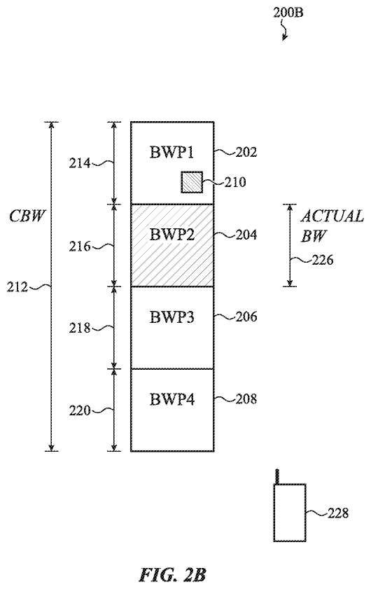

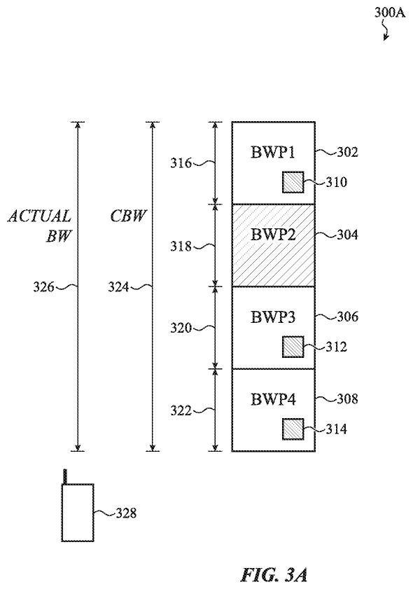

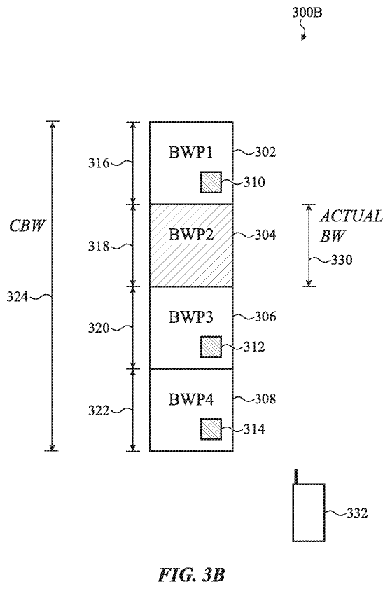

In some embodiments, and by way of a non-limiting example, the UE may be configured to perform L1 measurement operations on the CSI-RS and/or SSB received outside of the active BWP of the UE. The UE may perform L1 measurement operations on the CSI-RS and/or SSB received outside of the active BWP of the UE according to a UE type, as described herein with reference to FIGS. 2A-2B and 3A-3B.

FIG. 2A illustrates a relationship between a carrier bandwidth, bandwidth parts, and an actual bandwidth for one type of a user equipment (UE), for example, a UE 224, in which layer-1 reference signals are received in a single inactive bandwidth part, according to embodiments described herein. As shown in a diagram 200A in FIG. 2A, the UE 224 may be configured with multiple BWPs, for example, four different BWPs, BWP1 202, BWP2 204, BWP3 206, and BWP4 208. By way of a non-limiting example, the BWP2 204 may be configured as an active BWP for the UE 224. Each BWP may be of a different bandwidth. Thus, carrier bandwidth part (CBW) 212 of the UE 224 may be divided into multiple BWPs. The CBW 212 may be a contiguous set of physical resource blocks (PRBs). The contiguous set of PRBs may correspond with a particular numerology of a particular carrier. By way of a non-limiting example, as shown in FIG. 2A, each BWP may be of a different bandwidth, and, therefore, may have a different number of PRBs included in each BWP. For example, the BWP1 202, the BWP2 204, the BWP3 206, and the BWP4 208 may have corresponding bandwidth, as shown in FIG. 2A, as 214, 216, 218, and 220, respectively.

In some embodiments, and by way of a non-limiting example, the UE 224 may be of a UE type, which operates in an actual bandwidth 222 that is the same as the carrier bandwidth of the UE, for example, the CBW 212. The UE 224 may communicate its UE type to a base station (not shown in FIG. 2A) in a UE capability information message using RRC signaling. In some embodiments, and by way of a non-limiting example, the UE type may also be communicated to a base station in a MAC control element (MAC CE).

In some embodiments, and by way of a non-limiting example, the base station may inform the UE 224 of a BWP in which the SSB and/or CSI-RS are transmitted to the UE 224 for the UE 224 to perform L1 measurement operations, such as BM, RLM, and/or BFD, and so on. For example, the base station may specify, in an RRC signaling message to the UE 224, an ID of a BWP in which an SSB and/or a CSI-RS 210 are transmitted for the UE 224 to perform L1 measurement operations. For example, the base station may specify an ID of BWP1 202 in a RRC signaling message to the UE 224. The UE 224, which is of a UE type, in which an actual BW in which the UE 224 operates is the same as the CBW 212, would then perform one or more L1 measurement operations on the SSB and/or CSI-RS received in the BWP1 202, which is not an active BWP for the UE 224. The SSB and/or CSI-RS 210 on which the UE 224 performs one or more L1 measurement operations may also be referenced herein as L1 reference signals (L1-RSs).

As described herein, and in accordance with some embodiments, the L1 measurement operations may include one or more of a measurement for beam level mobility (BM), a measurement for radio link monitoring (RLM), and/or a measurement for beam failure detection and recovery (BFD), and so on.

In some embodiments, and by way of a non-limiting example, one or more L1-RSs may have a subcarrier spacing (SCS) different from a SCS of an active BWP of a UE. A UE may be operating in a frequency range of frequency range-1 (FR1) and/or a frequency range of frequency range-2 (FR2). In other words, the CBW 212 may be FR1 or FR2.

Accordingly, in some embodiments, and by way of a non-limiting example, in the FR1 and/or FR2, the UE 224 of the UE type, which operates in actual BW 222 that is the same as the CBW 212, and does not support simultaneous reception with different SCS, the UE 224 may not transmit PUCCH, PUSCH, and/or SRS on L1-RSs. Similarly, the UE 224 may not receive PDCCH, PDSCH, TRS, and/or CSR-RS from a base station for CQI on L1-RSs.

In some embodiments, and by way of a non-limiting example, in the FR2, the UE 224 of the UE type, which operates in actual BW 222 that is the same as the CBW 212, and does not support simultaneous reception with a different SCS, the UE 224 may not transmit PUCCH, PUSCH, and/or SRS on L1-RSs having a different transmission control indicator (TCI) than a TCI of an active BWP (e.g., the BWP2 204, in this case). Similarly, the UE 224 may not receive PDCCH, PDSCH, TRS, and/or CSR-RS from a base station for CQI on L1-RSs having a different transmission control indicator (TCI) than a TCI of an active BWP (e.g., the BWP2 204, in this case). One example of L1-RSs having a different TCI than a TCI of an active BWP may be a quasi-co-location (QCL) to a different SSB.

In some embodiments, and by way of a non-limiting example, in the FR1 and/or FR2, the UE 224 of the UE type, which operates in the actual BW 222 that is same as the CBW 212, and supports simultaneous reception with either a different SCS or the same SCS, the UE 224 may transmit PUCCH, PUSCH, and/or SRS on L1-RSs. Similarly, the UE 224 may receive PDCCH, PDSCH, TRS, and/or CSR-RS from a base station for CQI on L1-RSs.

In some embodiments, and by way of a non-limiting example, in the FR2, the UE 224 of the UE type, which operates in the actual BW 222 that is the same as the CBW 212, and does not support simultaneous reception with a different SCS, the UE 224 may transmit PUCCH, PUSCH, and/or SRS on L1-RSs having the same transmission control indicator (TCI) as a TCI of an active BWP (e.g., the BWP2 204, in this case), but restrict transmission if the L1-RS has a different TCI than a TCI of an active BWP. Similarly, the UE 224 may receive PDCCH, PDSCH, TRS, and/or CSR-RS from a base station for CQI on L1-RSs having the same TCI as a TCI of an active BWP (e.g., the BWP2 204, in this case), but restrict reception if the L1-RS has a different TCI than a TCI of an active BWP.

FIG. 2B illustrates a relationship between a carrier bandwidth, bandwidth parts, and an actual bandwidth for another type of a user equipment (UE), for example, a UE 228, in which layer-1 reference signals are received in a single inactive bandwidth part, according to embodiments described herein. As shown in a diagram 200B in FIG. 2B, the UE 228 may be configured with multiple BWPs, for example, four different BWPs, BWP1 202, BWP2 204, BWP3 206, and BWP4 208. By way of a non-limiting example, the BWP2 204 may be configured as an active BWP for the UE 228. Each BWP may be of a different bandwidth. Thus, a carrier bandwidth part (CBW) 212 of the UE 228 may be divided into multiple BWPs. The CBW 212 may be a contiguous set of physical resource blocks (PRBs). The contiguous set of PRBs may correspond with a particular numerology of a particular carrier. By way of a non-limiting example, and as shown in FIG. 2B, each BWP may be of a different bandwidth, and, therefore, may have a different number of PRBs included in each BWP. For example, the BWP1 202, the BWP2 204, the BWP3 206, and the BWP4 208 may have a corresponding bandwidth as 214, 216, 218, and 220, respectively, shown in FIG. 2B.

In some embodiments, and by way of a non-limiting example, the UE 228 may be of a UE type, which operate in an actual bandwidth 226 that is the same as a bandwidth of the active BWP (e.g., a bandwidth 216 of the BWP2 204). The UE 228 may communicate its UE type to a base station (not shown in FIG. 2B) in a UE capability information message using RRC signaling. In some embodiments, and by way of a non-limiting example, the UE type may also be communicated to a base station in a MAC control element (MAC CE).

In some embodiments, and by way of a non-limiting example, the base station may inform the UE 228 of a BWP in which the SSB and/or CSI-RS are transmitted for the UE 228 to perform L1 measurement operations, such as BM, RLM, and/or BFD, and so on. For example, the base station may specify, in a RRC signaling message to the UE 228, an ID of a BWP in which the SSB and/or CSI-RS 210 are transmitted for the UE 228 to perform L1 measurement operations. For example, the base station may specify an ID of BWP1 202 in an RRC signaling message to the UE 228. The UE 228, which is of a UE type, in which an actual BW in which the UE 228 operates is the same as the bandwidth of the active BWP of the UE (e.g., bandwidth of the BWP2 204), would then perform one or more L1 measurement operations on the SSB and/or CSI-RS 210 received in the BWP1 202, which is not an active BWP for the UE 228. The SSB and/or CSI-RS 210 on which the UE 228 performs one or more L1 measurement operations may be referenced as L1 reference signals (L1-RSs) in the present disclosure.

In some embodiments, and by way of a non-limiting example, the UE 228 may adjust its actual bandwidth according to a frequency offset of the received L1-RSs 210. For example, the UE 228 may adjust its actual bandwidth 226 to cover a portion of the bandwidth 214 of the BWP1 202 in which the L1-RSs 210 are received. Similarly, if the L1-RSs 210 are received in the bandwidth 218 of the BWP3 206, or the bandwidth 220 of the BWP4 208, the UE 228 may adjust its actual bandwidth to cover a portion of the bandwidth 218 or the bandwidth 220 in which the L1-RSs 210 may have been received.

In some embodiments, and by way of a non-limiting example, one or more L1-RSs may have a subcarrier spacing (SCS) different from an SCS of an active BWP of the UE. The UE may be operating in a frequency range of frequency range-1 (FR1) and/or a frequency range of frequency range-2 (FR2). In other words, the CBW 212 may be FR1 or FR2.

Accordingly, in some embodiments, and by way of a non-limiting example, in the FR1 and/or FR2, the UE 228 that is configured to adjust its actual bandwidth according to a frequency offset of the received L1-RSs 210 and not support simultaneous reception with different SCS, the UE 228 may not transmit PUCCH, PUSCH, and/or SRS on L1-RSs 210. Similarly, the UE 228 may not receive PDCCH, PDSCH, TRS, and/or CSR-RS from a base station for CQI on L1-RSs.

In some embodiments, and by way of a non-limiting example, in the FR2, the UE 228 that is configured to adjust its actual bandwidth according to a frequency offset of the received L1-RSs 210 and not support simultaneous reception with a different SCS, the UE 228 may not transmit PUCCH, PUSCH, and/or SRS on L1-RSs having a different transmission control indicator (TCI) than a TCI of an active BWP (e.g., the BWP2 204, in this case). Similarly, the UE 228 may not receive PDCCH, PDSCH, TRS, and/or CSR-RS from a base station for CQI on L1-RSs having a different transmission control indicator (TCI) than a TCI of an active BWP (e.g., the BWP2 204, in this case). As described herein, one example of L1-RSs having a different TCI than a TCI of an active BWP may be a quasi-co-location (QCL) to a different SSB.

In some embodiments, and by way of a non-limiting example, in the FR1 and/or FR2, the UE 228 that is configured to adjust its actual bandwidth according to a frequency offset of the received L1-RSs 210 and support simultaneous reception with a different SCS or the same SCS, the UE 228 may transmit PUCCH, PUSCH, and/or SRS on L1-RSs. Similarly, the UE 228 may receive PDCCH, PDSCH, TRS, and/or CSR-RS from a base station for CQI on L1-RSs.

In some embodiments, and by way of a non-limiting example, in the FR2, the UE 228 that is configured to adjust its actual bandwidth according to a frequency offset of the received L1-RSs 210 and support simultaneous reception with a different or the same SCS, the UE 228 may transmit PUCCH, PUSCH, and/or SRS on L1-RSs having the same transmission control indicator (TCI) as a TCI of an active BWP (e.g., the BWP2 204, in this case). Similarly, the UE 228 may receive PDCCH, PDSCH, TRS, and/or CSR-RS from a base station for CQI on L1-RSs having the same TCI as a TCI of an active BWP (e.g., the BWP2 204, in this case).

Additionally, or alternatively, in some embodiments, and by way of a non-limiting example, the UE 228 may use an additional radio frequency (RF) chain in its baseband processing circuitry to perform L1 measurement operations on L1-RSs, which are received in a BWP that is not an active BWP configured for the UE 228. Generally, an RF chain may be configured to operate within an actual BW of the UE that is the same as the bandwidth of an active BWP. However, when L1-RSs are scheduled by a base station to be transmitted to a UE in a non-active BWP, the UE may use an additional RF chain to receive and perform L1 measurement operations in a BWP in which the L1-RSs are received. For power saving, UE may only switch on the additional RF on the L1-RSs occasions. The additional RF chain may share some components with other RF chain(s) on a radio frequency integrated circuit (RFIC). Switching on/off the additional RF chain may cause short interruption to other RF chain(s). Accordingly, UE may be allowed to cause interruption on other serving cells before and after the L1-RSs. The interruption length depends on RF switching time, which may be pre-defined in 3GPP Technical Specifications, for example, 0.5 ms for serving cell(s) in FR1 and 0.25 ms for serving cell(s) in FR2.

In some embodiments, and by way of a non-limiting example, the UE 228 using an additional RF chain for performing L1 measurement operations on L1-RSs received in a non-active BWP may not restrict transmission of PUCCH, PUSCH, and/or SRS on L1-RSs, and/or reception of PDCCH, PDSCH, TRS, and/or CSR-RS from a base station for CQI on L1-RSs, while operating in FR1 and/or FR2. In some cases, however, the UE may restrict transmission of PUCCH, PUSCH, and/or SRS on L1-RSs, and/or reception of PDCCH, PDSCH, TRS, and/or CSR-RS from a base station for CQI on L1-RSs, while operating in FR1 and/or FR2, based on whether the UE supports independent beam management for different BWPs. In some embodiments, the UE may indicate to the base station whether the UE supports independent beam management for different BWPs in UE capability information using RRC signaling.

In some embodiments, and by way of a non-limiting example, a base station and/or a core network may configure one or more measurement gaps for a UE to perform L1 measurement operations on L1-RSs, which are received in a BWP that is not an active BWP configured for the UE. Accordingly, the UE may switch to a BWP in which the L1-RSs are received to perform L1 measurement operations on the received L1-RSs, and switch back to the active BWP upon performing L1 measurement operations. During a measurement gap, the UE may be configured not to transmit data and/or reference signals in an uplink direction, and/or receive data and/or reference signals in a downlink direction.

FIG. 3A illustrates a relationship between a carrier bandwidth, bandwidth parts, and an actual bandwidth for one type of a user equipment (UE), for example, a UE 328, in which layer-1 reference signals are received in multiple inactive bandwidth parts, according to embodiments described herein. As shown in a diagram 300A in FIG. 3A, the UE 328 may be configured with multiple BWPs, for example, four different BWPs, BWP1 302, BWP2 304, BWP3 306, and BWP4 308. By way of a non-limiting example, the BWP2 304 may be configured as an active BWP for the UE 328. Each BWP may be of a different bandwidth. Thus, a carrier bandwidth part (CBW) 324 of the UE 328 may be divided into multiple BWPs. The CBW 324 may be a contiguous set of physical resource blocks (PRBs). The contiguous set of PRBs may correspond with a particular numerology of a particular carrier. By way of a non-limiting example, as shown in FIG. 3A, each BWP may be of a different bandwidth, and, therefore, may have a different number of PRBs included in each BWP. For example, the BWP1 302, the BWP2 304, the BWP3 306, and the BWP4 308 may have a corresponding bandwidth, as shown in FIG. 3A, as 316, 318, 320, and 322, respectively.

In some embodiments, and by way of a non-limiting example, the UE 328 may be of a UE type which operates in an actual bandwidth 326 that is the same as the carrier bandwidth, CBW 324. The UE 328 may communicate its UE type to a base station (not shown in FIG. 3A) in a UE capability information message using RRC signaling. In some embodiments, and by way of a non-limiting example, the UE type may also be communicated to a base station in a MAC control element (MAC CE).

In some embodiments, and by way of a non-limiting example, the base station may inform the UE 328 of a BWP in which one or more SSBs and/or CSI-RSs 310, 312, and/or 314 are transmitted to the UE 328, for the UE 328 to perform one or more L1 measurement operations, such as BM, RLM, and/or BFD, and so on. For example, the base station may specify, in one or more RRC signaling messages to the UE 328, an ID of each BWP in which the SSBs and/or CSI-RSs 310, 312, and/or 314 are transmitted for the UE 328 to perform L1 measurement operations. For example, the base station may specify, in one or more RRC signaling messages, an ID of BWP1 302 for the SSB and/or CSI-RS 310, an ID of BWP3 306 for the SSB and/or CSI-RS 312, and/or an ID of BWP4 308 for the SSB and/or CSI-RS 314. In some embodiments, and by way of a non-limiting example, each of the SSBs and/or CSI-RSs 310, 312, and 314 may be for performing a particular L1 measurement operation, such as, a BM, an RLM, and/or a BFD, and so on.

In some embodiments, and by way of a non-limiting example, one or more L1-RSs 310, 312, and/or 314 may have a subcarrier spacing (SCS) different from a SCS of an active BWP of the UE 328. The UE 328 may be operating in a frequency range of frequency range-1 (FR1) and/or a frequency range of frequency range-2 (FR2). In other words, the CBW 324 may be a portion of the FR1 or FR2.

In some embodiments, the UE 328 may be similar to the UE 224, and, therefore, may allow or restrict transmission and/or reception of data and/or reference signals, as described herein in accordance with some embodiments, using FIG. 2A.

FIG. 3B illustrates a relationship between a carrier bandwidth, bandwidth parts, and an actual bandwidth for another type of a user equipment (UE), for example, a UE 332, in which layer-1 reference signals are received in multiple inactive bandwidth parts, according to embodiments described herein. As shown in a diagram 300B in FIG. 3B, the UE 332 may be configured with multiple BWPs, for example, four different BWPs, BWP1 302, BWP2 304, BWP3 306, and BWP4 308. By way of a non-limiting example, the BWP2 304 may be configured as an active BWP for the UE 332. Each BWP may be of a different bandwidth. Thus, a carrier bandwidth part (CBW) 324 of the UE 332 may be divided into multiple BWPs. The CBW 324 may be a contiguous set of physical resource blocks (PRBs). The contiguous set of PRBs may correspond with a particular numerology of a particular carrier. By way of a non-limiting example, as shown in FIG. 3B, each BWP may be of a different bandwidth, and, therefore, may have a different number of PRBs included in each BWP. For example, the BWP1 302, the BWP2 304, the BWP3 306, and the BWP4 308 may have a corresponding bandwidth shown in FIG. 3B as 316, 318, 320, and 322, respectively.

In some embodiments, and by way of a non-limiting example, the UE 332 may be of a UE type, which operates in an actual bandwidth 330 that is the same as a bandwidth of the active BWP (e.g., a bandwidth 318 of the BWP2 304). The UE 332 may communicate its UE type to a base station (not shown in FIG. 3B) in a UE capability information message using RRC signaling. In some embodiments, and by way of a non-limiting example, the UE type may also be communicated to a base station in a MAC control element (MAC CE).

In some embodiments, and by way of a non-limiting example, the base station may inform the UE 332 of one or more BWPs in which one or more SSBs and/or CSI-RSs are transmitted to the UE 332 for the UE 332 to perform L1 measurement operations, such as BM, RLM, and/or BFD, and so on. For example, the base station may specify in one or more RRC signaling messages to the UE 332, an ID of each BWP in which the one or more SSBs and/or CSI-RSs, for example, 310, 312, and/or 314, are transmitted for the UE 332 to perform L1 measurement operations. For example, the base station may specify an ID of one or more of the BWP1 302, the BWP3 306, and/or the BWP4 308, in one or more RRC signaling messages to the UE 332. The UE 332, which is of a UE type, in which an actual BW in which the UE 332 operates is the same as the bandwidth of the active BWP of the UE (e.g., the bandwidth 318 of the BWP2 304), would then perform one or more L1 measurement operations on the received one or more SSBs and/or CSI-RSs 310, 312, and/or 314.

In some embodiments, and by way of a non-limiting example, the UE 332 may adjust its actual bandwidth according to a frequency offset of the received L1-RSs 310, 312, and/or 314. For example, the UE 332 may adjust its actual bandwidth 330 to cover a portion of the bandwidth 316, the bandwidth 320, and/or the bandwidth 322 in which the L1-RSs may have been received, as described herein, in accordance with some embodiments.

Further, in accordance with some embodiments, UE 332 may communicate, or restrict transmission and/or reception, of data and/or reference signals, in a similar way as described herein with reference to UE 228. Accordingly, those embodiments and corresponding descriptions are not described again for brevity.

In some embodiments, and by way of a non-limiting example, a UE 332 may use an additional radio frequency (RF) chain in its baseband processing circuitry to perform L1 measurement operations on L1-RSs, which are received in a BWP that is not an active BWP configured for the UE 332. Generally, an RF chain may be configured to operate within an actual BW of the UE that is the same as the bandwidth of an active BWP. However, when L1-RSs are scheduled by a base station to be transmitted to a UE in a non-active BWP, the UE may use an additional RF chain to receive and perform L1 measurement operations in a BWP in which the L1-RSs are received.

In some embodiments, and by way of a non-limiting example, the UE 332 using an additional RF chain for performing L1 measurement operations on L1-RSs received in a non-active BWP may not restrict transmission of PUCCH, PUSCH, and/or SRS on L1-RSs, and/or reception of PDCCH, PDSCH, TRS, and/or CSR-RS from a base station for CQI on L1-RSs, while operating in FR1 and/or FR2. In some cases, however, the UE 332 may restrict transmission of PUCCH, PUSCH, and/or SRS on L1-RSs, and/or reception of PDCCH, PDSCH, TRS, and/or CSR-RS from a base station for CQI on L1-RSs, while operating in FR1 and/or FR2, based on whether the UE supports independent beam management for different BWPs. In some embodiments, the UE may indicate to the base station whether the UE supports independent beam management for different BWPs in UE capability information using RRC signaling.

In some embodiments, and by way of a non-limiting example, a base station and/or a core network may configure one or more measurement gaps for the UE 332 to perform L1 measurement operations on L1-RSs, which are received in a BWP that is not an active BWP configured for the UE. Accordingly, the UE may switch to a BWP in which the L1-RSs are received to perform L1 measurement operations on the received L1-RSs, and switch back to the active BWP upon performing L1 measurement operations. During a measurement gap, the UE may be configured not to transmit data and/or reference signals in an uplink direction, and/or receive data and/or reference signals in a downlink direction.

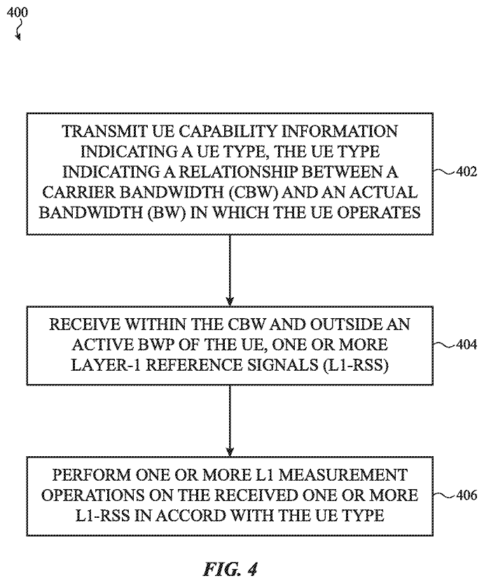

FIG. 4 illustrates an example flow-chart of operations that may be performed by a UE, according to embodiments described herein. As shown in a flow-chart 400 in FIG. 4, at 402, a UE may transmit UE capability information to a base station. The UE capability information may include information about a UE type of the UE. The UE type may indicate a relationship between CBW and an actual BW in which the UE may operate. As described herein, in some embodiments, and by way of a non-limiting example, a UE may be similar to the UE 224 or the UE 328, which operates in an actual BW that is the same as the CBW. In some embodiments, and by way of a non-limiting example, a UE may be similar to the UE 228 or the UE 332, which operates in an actual BW that is the same as the BW of the active BWP configured for the UE. The UE may transmit the UE type in the UE capability information using RRC signaling and/or as a MAC CE.

At 404, the UE may receive within the CBW of the UE, but outside of an active BWP of the UE, one or more SSBs and/or CSI-RSs (or layer-1 reference signals (L1-RSs), as described herein). The UE may receive a communication regarding scheduling of the L1-RSs from a base station. Accordingly, the UE may be aware of the L1-RSs and its corresponding BWPs.

At 406, the UE may perform one or more L1 measurement operations on the received L1-RSs in accordance with the UE type. Accordingly, the UE of the UE type similar to the UE type of the UE 224 or the UE 328, may perform the one or more L1 measurement operations, as described herein, in accordance with some embodiments, using FIG. 2A and/or FIG. 3A, and the UE of the UE type similar to the UE type of the UE 228 or the UE 332, may perform the one or more L1 measurement operations, as described herein, in accordance with some embodiments, using FIG. 2B and/or FIG. 3B.

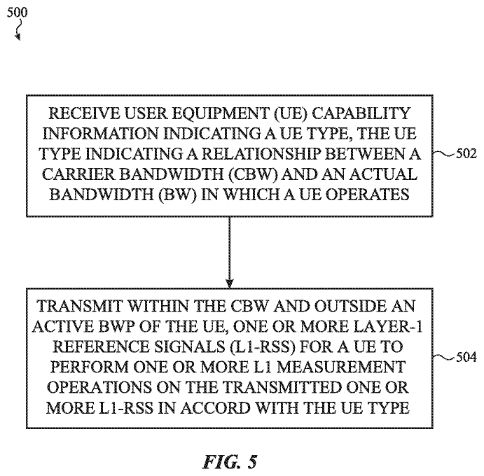

FIG. 5 illustrates an example flow-chart of operations that may be performed by a base station, according to embodiments described herein. As shown in a flow-chart 500 in FIG. 5, at 502, a base station may receive, from a UE, UE capability information. The UE capability information may include information about a UE type of the UE. The UE type may indicate a relationship between CBW and an actual BW in which the UE may operate. As described herein, in some embodiments, and by way of a non-limiting example, a UE may be similar to the UE 224 or the UE 328, which operates in an actual BW that is the same as the CBW. In some embodiments, and by way of a non-limiting example, a UE may be similar to the UE 228 or the UE 332, which operates in an actual BW that is the same as the BW of the active BWP configured for the UE. The UE capability information may be received by the base station as RRC signaling and/or as a MAC CE.

At 504, the base station may transmit, to the UE, one or more SSBs and/or CSI-RSs (or L1-RSs, as described herein). The L1-RSs may be transmitted within the CBW of the UE, but outside of an active BWP of the UE. The base station may also communicate to the UE regarding scheduling of the L1-RSs. Accordingly, the UE may be aware of the L1-RSs and its corresponding BWPs, and perform one or more L1 measurement operations according to a UE type, as described herein, in accordance with some embodiments.

In some embodiments, and by way of a non-limiting example, the base station may also transmit scheduling or transmission restrictions to the UE for the UE having a CBW in a frequency range of FR1 and/or FR2. In one example, if the UE indicates in UE capability information or other RRC signaling message that the UE is not configured to support beam management for different BWPs of the UE independent of each other, the base station may restrict transmission and/or reception of data and/or reference signals in the FR1 frequency range.

Embodiments contemplated herein include an apparatus having means to perform one or more elements of the method 400, or 500. In the context of method 400, this apparatus may be, for example, an apparatus of a UE (such as a wireless device 702 that is a UE, as described herein). In the context of method 500, this apparatus may be, for example, an apparatus of a base station (such as a network device 720 that is a base station, as described herein).

Embodiments contemplated herein include one or more non-transitory computer-readable media storing instructions to cause an electronic device, upon execution of the instructions by one or more processors of the electronic device, to perform one or more elements of the method 400, or 500. In the context of method 400, this non-transitory computer-readable media may be, for example, a memory of a UE (such as a memory 706 of a wireless device 702 that is a UE, as described herein). In the context of method 500, this non-transitory computer-readable media may be, for example, a memory of a base station (such as a memory 724 of a network device 720 that is a base station, as described herein).

Embodiments contemplated herein include an apparatus having logic, modules, or circuitry to perform one or more elements of the method 400, or 500. In the context of method 400, this apparatus may be, for example, an apparatus of a UE (such as a wireless device 702 that is a UE, as described herein). In the context of method 500, this apparatus may be, for example, an apparatus of a base station (such as a network device 720 that is a base station, as described herein).

Embodiments contemplated herein include an apparatus having one or more processors and one or more computer-readable media, using or storing instructions that, when executed by the one or more processors, cause the one or more processors to perform one or more elements of the method 400, or 500. In the context of method 400, this apparatus may be, for example, an apparatus of a UE (such as a wireless device 702 that is a UE, as described herein). In the context of the method 500, this apparatus may be, for example, an apparatus of a base station (such as a network device 720 that is a base station, as described herein).

Embodiments contemplated herein include a signal as described in or related to one or more elements of the method 400, or 500.

Embodiments contemplated herein include a computer program or computer program product having instructions, wherein execution of the program by a processor causes the processor to carry out one or more elements of the method 400, or 500. In the context of method 400, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein). In the context of method 500, the processor may be a processor of a base station (such as a processor(s) 722 of a network device 720 that is a base station, as described herein), and the instructions may be, for example, located in the processor and/or on a memory of the base station (such as a memory 724 of a network device 720 that is a base station, as described herein).

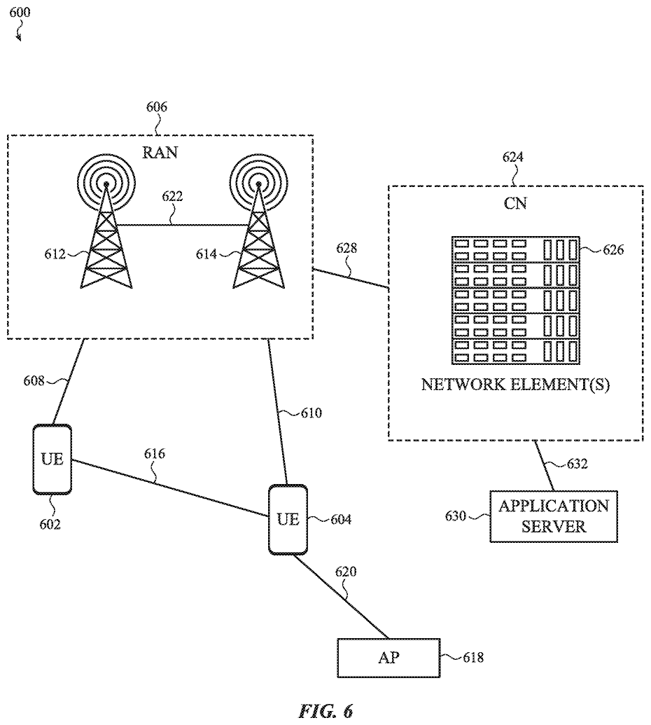

FIG. 6 illustrates an example architecture of a wireless communication system, according to embodiments described herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations, such as base station 612 and base station 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 602.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VOIP sessions, group communication sessions, etc.) for the UE 602 and UE 604 via the CN 624. The application server 630 may communicate with the CN 624 through an IP communications interface

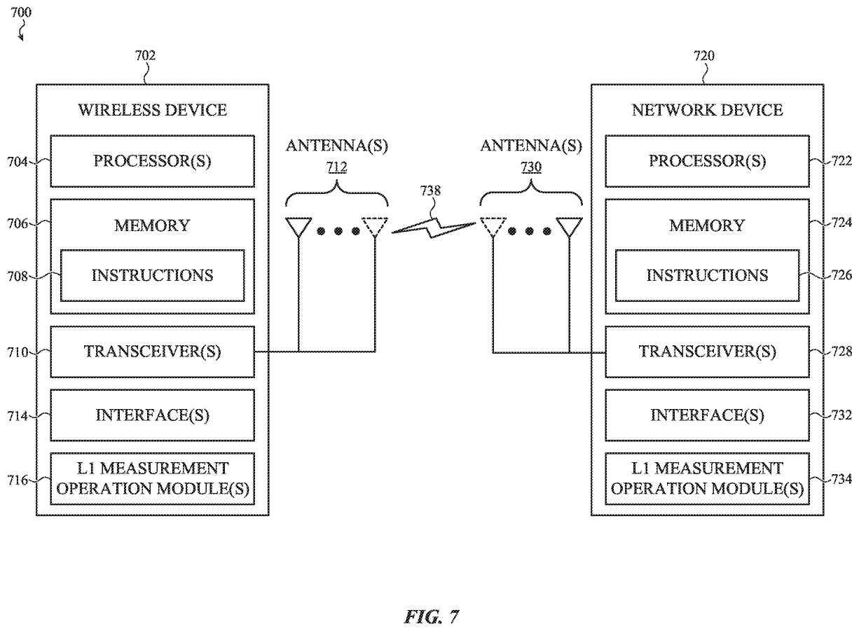

FIG. 7 illustrates a system 700 for performing signaling 738 between a wireless device 702 and a network device 720, according to embodiments described herein. The system 700 may be a portion of a wireless communication system as herein described. The wireless device 702 may be, for example, a UE of a wireless communication system. The network device 720 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a L1 measurement operation module 716. The L1 measurement operation module 716 may be implemented via hardware, software, or combinations thereof. For example, the L1 measurement operation module 716 may be implemented as a processor, circuit, and/or instructions 708 stored in the memory 706 and executed by the processor(s) 704. In some examples, the L1 measurement operation module 716 may be integrated within the processor(s) 704 and/or the transceiver(s) 710. For example, the L1 measurement operation module 716 may be implemented by a combination of software components (e.g., executed by a DSP or a general processor) and hardware components (e.g., logic gates and circuitry) within the processor(s) 704 or the transceiver(s) 710.

The L1 measurement operation module 716 may be used for various aspects of the present disclosure, for example, aspects of FIGS. 1-4, from the UE perspective. The L1 measurement operation module 716 may be configured to, for example, determine or identify a UE type and transmit it to the base station in UE capability information, and perform one or more L1 measurement operations on the received one or more SSBs and/or CSI-RSs in one or more inactive BWPs.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 that is a base station may include interface(s) 732 made up of transmitters, receivers, and other circuitry (e.g., other than the transceiver(s) 728/antenna(s) 730 already described) that enables the base station to communicate with other equipment in a core network, and/or that enables the base station to communicate with external networks, computers, databases, and the like for purposes of operations, administration, and maintenance of the base station or other equipment operably connected thereto.

The network device 720 may include a L1 measurement operation module 734. The L1 measurement operation module 734 may be implemented via hardware, software, or combinations thereof. For example, the L1 measurement operation module 734 may be implemented as a processor, circuit, and/or instructions 726 stored in the memory 724 and executed by the processor(s) 722. In some examples, the L1 measurement operation module 734 may be integrated within the processor(s) 722 and/or the transceiver(s) 728. For example, the L1 measurement operation module 734 may be implemented by a combination of software components (e.g., executed by a DSP or a general processor) and hardware components (e.g., logic gates and circuitry) within the processor(s) 722 or the transceiver(s) 728.

The L1 measurement operation module 734 may be used for various aspects of the present disclosure, for example, aspects of FIGS. 1 and 5, from a base station perspective. The L1 measurement operation module 734 may be configured to, for example, receive UE type information in UE capability information, as described herein, and transmit one or more SSBs and/or CSI-RSs in one or more inactive BWPs to the UE, for the UE to perform one or more L1 measurement operations on the transmitted SSBs and/or CSI-RSs.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to:
transmit, via the transceiver, UE capability information indicating a UE type, the UE type indicating a relationship between a carrier bandwidth (CBW) and an actual bandwidth (BW) in which the UE operates, the CBW including a plurality of bandwidth parts (BWPs);
receive, via the transceiver, within the CBW and outside an active BWP of the UE, via the transceiver, one or more layer-1 (L1) reference signals (L1-RSs); and
perform one or more L1 measurement operations on the received one or more L1-RSs, the one or more L1 measurement operations performed in accord with the UE type.

2. The UE of claim 1, wherein the one or more L1 measurement operations comprise:
a measurement for beam level mobility;
a measurement for radio link monitoring; or
a measurement for beam failure detection and recovery.

3. The UE of claim 1, wherein the one or more L1-RSs associated with the one or more L1 measurement operations have a subcarrier spacing (SCS) that is different from a SCS of the active BWP.

4. The UE of claim 3, wherein:
the processor is configured to:
determine the UE is configured to support concurrent intra-frequency measurement on a serving cell or a neighboring cell using physical downlink control channel (PDCCH) or physical downlink shared channel (PDSCH) reception from the serving cell with a different numerology; and
communicate data or reference signals in an uplink or a downlink direction in response to determining the UE is configured to support the concurrent intra-frequency measurement on the serving cell or the neighboring cell using the PDCCH or PDSCH reception.

5. The UE of claim 3, wherein:
the processor is further configured to:
determine the UE is not configured to support concurrent intra-frequency measurement on a serving cell or a neighboring cell using physical downlink control channel (PDCCH) or physical downlink shared channel (PDSCH) reception from the serving cell with a different numerology; and
restrict communication of data or reference signals in an uplink or a downlink direction in response to determining the UE is not configured to support the concurrent intra-frequency measurement on the serving cell or the neighboring cell using the PDCCH or PDSCH reception.

6. The UE of claim 5, wherein:
the CBW is in a frequency range of frequency range-2 (FR2); and
a transmission configuration indicator (TCI) associated with the one or more L1-RSs is different from a TCI associated with the active BWP.

7. The UE of claim 1, wherein the CBW is in a frequency range of frequency range-1 (FR1) or frequency range-2 (FR2).

8. The UE of claim 1, wherein the UE type suggests the actual BW in which the UE operates is the same as the CBW.

9. The UE of claim 1, wherein the UE type suggests the actual BW in which the UE operates is the same as the active BWP.

10. The UE of claim 9, wherein the processor is configured to:
adjust a bandwidth of the active BWP for operation of the UE according to a frequency offset of the received one or more L1-RSs.

11. The UE of claim 9, wherein to perform the one or more L1 measurement operations on the received one or more L1-RSs in accord with the UE type, the processor is configured to:
use an additional radio frequency (RF) chain according to a frequency offset of the received one or more L1-RSs.

12. The UE of claim 9, wherein:
the CBW is in a frequency range of frequency range-1 (FR1); and
the processor is configured to:
restrict communication of data or reference signals in an uplink or a downlink direction in response to determining that the UE is not configured to support beam management for different BWPs independent of each other.

13. The UE of claim 9, wherein:
the CBW is in a frequency range of frequency range-2 (FR2); and
the processor is configured to:
restrict communication of data or reference signals in an uplink or a downlink direction.

14. A method, comprising:
transmitting, from a user equipment (UE) to a base station, and via a transceiver of the UE, UE capability information indicating a UE type, the UE type indicating a relationship between a carrier bandwidth (CBW) and an actual bandwidth (BW) in which the UE operates, the CBW including a plurality of bandwidth parts (BWPs);
receiving, via the transceiver, within the CBW and outside an active BWP of the UE, one or more layer-1 (L1) reference signals (L1-RSs); and
performing one or more L1 measurement operations on the received one or more L1-RSs in accord with the UE type.

15. The method of claim 14, wherein the one or more L1 measurement operations comprise:
a measurement for beam level mobility;
a measurement for radio link monitoring; or
a measurement for beam failure detection and recovery.

16. The method of claim 14, wherein the one or more L1-RSs associated with the one or more L1 measurement operations have a subcarrier spacing (SCS) that is different from a SCS of the active BWP.

17. The method of claim 16, further comprising:
determining whether the UE is configured to support concurrent intra-frequency measurement on a serving cell or a neighboring cell using physical downlink control channel (PDCCH) or physical downlink shared channel (PDSCH) reception from the serving cell with a different numerology;
in response to determining the UE is configured to support the concurrent intra-frequency measurement on the serving cell or the neighboring cell using the PDCCH or PDSCH reception, communicating data or reference signals in an uplink or a downlink direction; and
in response to determining the UE is not configured to support the concurrent intra-frequency measurement on the serving cell or the neighboring cell using the PDCCH or PDSCH reception, restricting communication of data or reference signals in an uplink or a downlink direction.

18. The method of claim 14, wherein the UE type suggests the actual BW in which the UE operates is the same as the CBW or the active BWP.

19. A base station, comprising:
a transceiver; and
a processor configured to:
receive, via the transceiver, user equipment (UE) capability information indicating a UE type, the UE type indicating a relationship between a carrier bandwidth (CBW) and an actual bandwidth (BW) in which a UE operates, the CBW including a plurality of bandwidth parts (BWPs); and
transmit, via the transceiver, within the CBW and outside an active BWP of the UE, one or more layer-1 (L1) reference signals (L1-RSs) for the UE to perform one or more L1 measurement operations on the transmitted one or more L1-RSs in accord with the UE type,
wherein the UE type suggests the actual BW in which the UE operates is the same as the CBW, or the active BWP.

20. The base station of claim 19, wherein:
the one or more L1-RSs associated with the one or more L1 measurement operations have a subcarrier spacing (SCS) that is different from a SCS of the active BWP;
the CBW is in a frequency range of frequency range-1 (FR1) or frequency range-2 (FR2); and
the processor is configured to:
in the FR1, restrict communication of data or reference signals in an uplink or a downlink direction in response to determining that the UE is not configured to support beam management for different BWPs independent of each other; and
in the FR2, restrict the communication of data or reference signals in the uplink or the downlink direction.
